(19) United States
(12) Patent Application Publication
(10) Pub. No.: US 2012/0227721 A1
(43) Pub. Date: Sep. 13, 2012

(54) Foldable Compact Ball Thrower

(76) Inventor: Tamar Geller, Los Angeles, CA (US)

(21) Appl. No.: 13/412,522

(22) Filed: Mar. 5, 2012

Related U.S. Application Data
(60) Provisional application No. 61/448,760, filed on Mar. 3, 2011.

(51) Int. Cl. A63B 65/12; B23P 11/00

(52) U.S. Cl. 124/5; 29/428

(57) ABSTRACT

The present invention pertains generally to a ball throwing apparatus. More specifically, the present invention pertains to a tennis ball throwing apparatus with an elongated shaft that may be folded in half. The shaft of the throwing apparatus has a claw-like structure with a plurality of elongate members attached or formed at one end for releasing the ball when throwing and picking up a ball without the user making direct contact with the ball and a partial spherical structure attached to or formed at the opposite end of the shaft for storing an extra ball.

### PRIORITY INFORMATION

This application claims priority from U.S. Provisional Application No. 61/448,760, filed on Mar. 3, 2011, the contents of which are hereby incorporated by reference.

### FIELD OF THE INVENTION

The present invention pertains generally to a ball throwing apparatus. More specifically, the present invention pertains to a tennis ball throwing apparatus with an elongated shaft that may be folded in half. The shaft of the throwing apparatus has a claw-like structure attached or formed at one end for releasing the ball when throwing and picking up a ball without the user making direct contact with the ball and a partial spherical structure attached to or formed at the opposite end of the shaft for holding an extra ball.

### BACKGROUND OF THE INVENTION

Many canine breeds are natural retrievers. Pet owners often take advantage of this inherent desire of dogs to retrieve as a means of engaging companion dogs in physical activity. Fetch can be a great source of exercise for dogs but the repetitive motion may have a negative impact on pet owners who desire to engage in such activities with their dogs on a regular, even daily basis. Typically, the pet owner must throw the ball for the dog to fetch, resulting in the owner's arm becoming weaker as the game progresses, especially in the case of dogs that require a game of fetch to continue for a considerable duration. Additionally, elderly or physically impaired pet owners may find it difficult to bend over repeatedly to retrieve the ball from their dog and/or the ground once retrieved. During the game of fetch, the ball will inevitably become coated in the saliva of the dog, requiring the owner to come into direct contact with the saliva in order to grab the ball for the next throw, unless the owner desires to wear gloves or use some other means to avoid touching the saliva directly. Additionally, other ball throwing devices may be awkward and/or cumbersome to handle when transporting to and from the location of the game of fetch.

Currently, there are several ball throwing devices available for pet owners whose dogs enjoy playing fetch for exercise and/or fun. Such devices range from man powered to automatic and/or remote controlled.

U.S. Pat. No. 6,076,829 to Oblack describes a ball throwing apparatus and method for playing the game of fetch with an animal. Oblack further describes an apparatus with a ball engaging means designed to allow the user to easily engage and pick up a ball without having to touch the ball with one's hands or fingers.

U.S. Pat. No. 7,686,001 to Fitt describes a throwing apparatus comprising an elongated handle and a cup mounted on the handle at or adjacent one end thereof. The cup is shaped to receive a throwable, non spherical, object, i.e. a football.

United States Patent Publication No. 2009/0025699 to Mongkolkasetarin et al. describes a device for throwing an object which includes a body having a first and second end, where the second end is connected to a pivot mechanism, and a swingable arm rotatable between a first position and a second position.

United States Patent Publication No. 2012/0006309 to Levin et al. describes a ball thrower which includes a throwing end and a reserve end.

United States Patent Publication No. 2012/0031385 to Fisher describes a ball throwing device including a shaft having a first and second end and a ball holder formed on the first end.

United States Patent Publication No. 2012/0048251 to Oblack et al. describes a pet toy suitable for indoor use including a launcher having a rigid handle, a flexible arm, and a C-shaped head attached to the distal end of the arm.

The Hyperdog™ Ball Launcher is a sling shot that is designed to shoot tennis balls over 200 feet and allows for hands free ball pick up.

The Hyper Products® Doggie Driver is a ball launcher modeled after a normal golf club. The tapered steel shaft provides a golf-grade grip and the head of the club has an opening for the ball that allows for hands free, no bending ball retrieval.

The Ballistic Dog™ Ball Blaster is a ball launcher with a tennis racket style handle that retracts from 27 inches fully extended to 10.5 inches. The built in ball receptor allows for hands free ball retrieval.

The Double Whammy is a ball launcher shaped like a hollowed out plastic baseball bat that allows the user to launch a tennis balls lacrosse style or by hitting them with the bat. The end of the bat has a built in ball retriever that allows for hands free ball retrieval.

The Fetchtastic Automatic Fetch Machine is a battery or AC-powered ball launcher that holds 15 regular or small tennis balls and automatically launches a ball every 7 seconds so long as there are balls in the machine. This device allows the dog to play fetch endlessly without requiring any physical exertion on the part of the owner.

The GoDogGo® Remote Fetch is a battery or AC-powered ball launcher that can be set to launch tennis balls at two time settings and three launch distances automatically or by owner control using the provided remote control. This device is similar to but more advanced than the Fetchtastic described above.

In light of the above, it is an object of the present invention to provide the desired features described herein as well as additional advantages providing a ball throwing apparatus that is effective at throwing long distances but also quick, easy, and inexpensive to manufacture. Another object of the present invention is to provide a compact, foldable throwing apparatus that is easy to store and transport when traveling with one's pet or alternatively when not in use.

The invention can be better visualized by turning now to the following drawings wherein like elements are referenced by like numerals.

### SUMMARY OF THE INVENTION

The present invention provides a ball thrower comprising: a throwing arm, the throwing arm comprising a throwing end and a first joint end, wherein the throwing end and the first joint end are oppositely disposed on the throwing arm; the throwing end holds and releases a ball; a grip-molded handle arm, the arm comprising a storage end and a second joint end, wherein the storage end and the second joint end are oppositely disposed on the grip-molded handle arm; the first joint end is in a hinging engagement with the second joint end; and the storage end holds the ball. Additionally, the throwing end holds and releases a first ball while the storage end holds a second ball.

In a first aspect, the present invention provides a ball thrower wherein the grip-molded handle arm and the throwing arm lock in an open position. Alternatively, the grip-molded handle arm and the throwing arm collapse to a collapsed position.

In a second aspect, the present invention provides a ball thrower with a clip. Additionally, the clip is removably engaged to the ball thrower.

In a third aspect, the present invention provides a ball thrower wherein the storage end and the throwing end hold a range of different sized balls. Additionally, the storage end holds the ball in a more secure engagement than the throwing end holds the ball.

In a fourth aspect, the present invention provides a ball thrower wherein the throwing end includes a plurality of elongate members that hold the ball, wherein the elongate members have an accurate shape and extend from the central portion of the throwing end to define a first holding area for holding the ball, and further wherein the elongate members include or terminate at rounded members, which maintain the ball in the throwing end until the ball is thrown from the throwing end. Additionally, the elongate members extend from a central portion, and the elongate members flex or bend with respect to the central portion to accommodate and hold a range of different sized balls.

In a fifth aspect, the present invention provides a ball thrower wherein the hinging engagement includes a pin that passes through portions of the first joint end and the second joint end. Additionally, the pin passes through pivot holes of the throwing arm and the grip-molded handle arm to provide for the hinging of the throwing arm and the grip-molded handle arm to open or collapse the ball thrower, and the pin passes through locking holes of the throwing arm and the grip-molded handle arm in order to lock the ball thrower open. Still further, the pin passes through an internal diameter of the spring, and the pin is biased by the spring.

In a sixth aspect, the present invention provides a ball thrower comprising: a throwing arm, the throwing arm comprising a throwing end; the throwing end releases a ball during a throwing motion; a grip-molded handle arm, the grip-molded handle arm comprising a storage end; and the storage end holds the ball in a secure engagement. Additionally, the throwing end releases a first ball or a second ball, and the storage end holds the first ball or the second ball in a secure engagement.

In a seventh aspect, the present invention provides a ball thrower comprising: a first arm, the first arm comprising a throwing end and a first joint end, wherein the throwing end and the first end are oppositely disposed on the first arm; the throwing end releases a ball; a second arm, the second arm comprising a second joint end; the first joint end is in a hinging engagement with the second joint end; and the hinging engagement comprising a locking member that locks the throwing arm and the storage arm in an open position.

In an eighth aspect, the present invention provides a method of using a ball thrower, comprising: providing a ball thrower, wherein the ball thrower comprises a first arm, the first arm comprising a throwing end and a first joint end, wherein the throwing end and the first joint end are oppositely disposed on the first arm; the throwing end releases a ball; a second arm, the second arm comprising a second joint end; the first joint end in a hinging engagement with the second joint end; opening the ball thrower; locking the ball thrower in an open position; throwing the ball from the throwing end of the ball thrower; and further comprising unlocking the ball thrower and collapsing the ball thrower.

In a ninth aspect, the present invention provides a method of using a ball thrower, comprising: providing a ball thrower, wherein the ball thrower comprises a throwing end and a storage end, wherein the throwing end and the storage end are oppositely disposed on the ball thrower; the throwing end releases a ball; and the storage end holds the ball; removing the ball from the storage end; placing the ball in the throwing end; throwing the ball from the throwing end of the ball thrower, and further comprising throwing a first ball from the throwing end while storing a second ball in the storage end.

In a tenth aspect, the present invention provides a method of manufacturing a ball thrower, comprising: providing a first arm and a second arm, wherein the first arm comprises a throwing end to release a ball when a throwing motion is applied to the ball thrower; and, engaging the first arm to the second arm in a hinging engagement via a hinging member; wherein the second arm hinges relative to the first arm, wherein the hinging member locks and unlocks the second arm relative to the first arm.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a side perspective view of the ball throwing apparatus in the folded, compact configuration.

FIG. 2 is a side perspective view of the ball throwing apparatus with the handle extended to full length.

FIG. 3 is a perspective view of the ball throwing apparatus showing an extra ball engaged in the ball storage head of the apparatus.

FIG. 4 is a perspective view of the ball throwing apparatus showing a ball engaged in the claw-like ball throwing head of the apparatus.

### DETAILED DESCRIPTION OF THE INVENTION

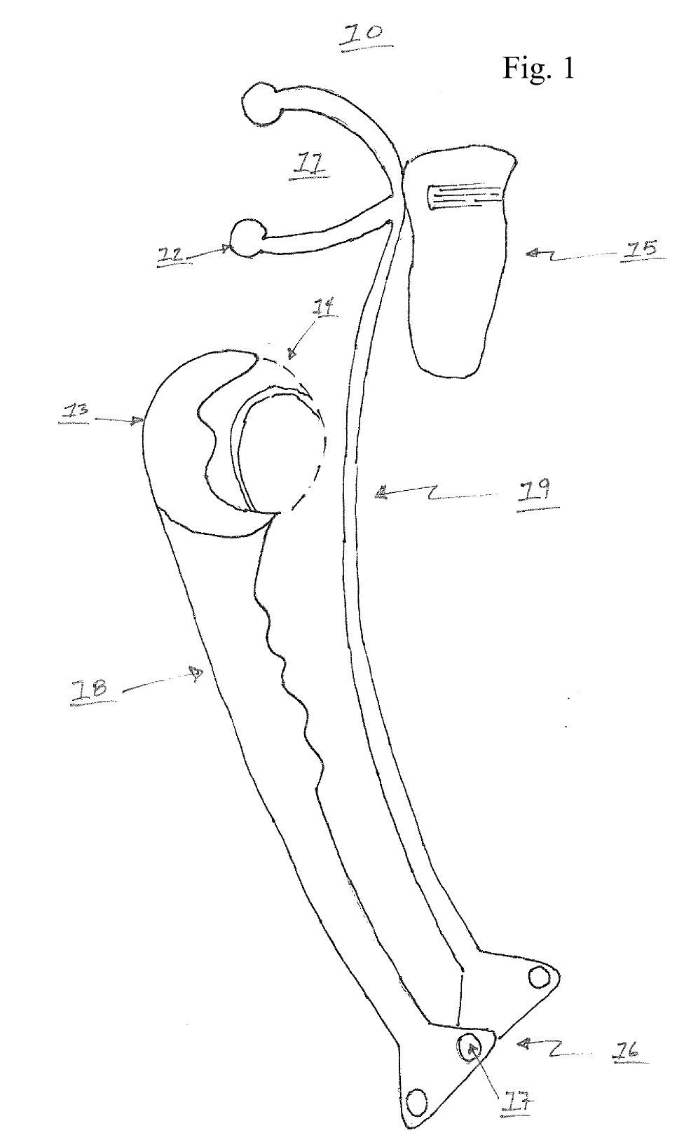

A ball throwing apparatus 10 is illustrated in a side perspective view in FIG. 1. The ball throwing apparatus 10 has a foldable shaft which folds using a steel pin 17 around a pivot point 16. The shaft is divided into two sections: 1) a grip-molded handle arm 18; and a curved throwing arm 19. The curved throwing arm of the shaft 19 has a claw-like structure 11 with a plurality of elongate members 12 on one end that engages a ball 14, i.e. a tennis ball, for throwing. The curved throwing arm also has a built in belt clip 15. The grip-molded handle arm of the shaft 18 has partial spherical structure 13 on the end that engages and stores an extra ball 14.

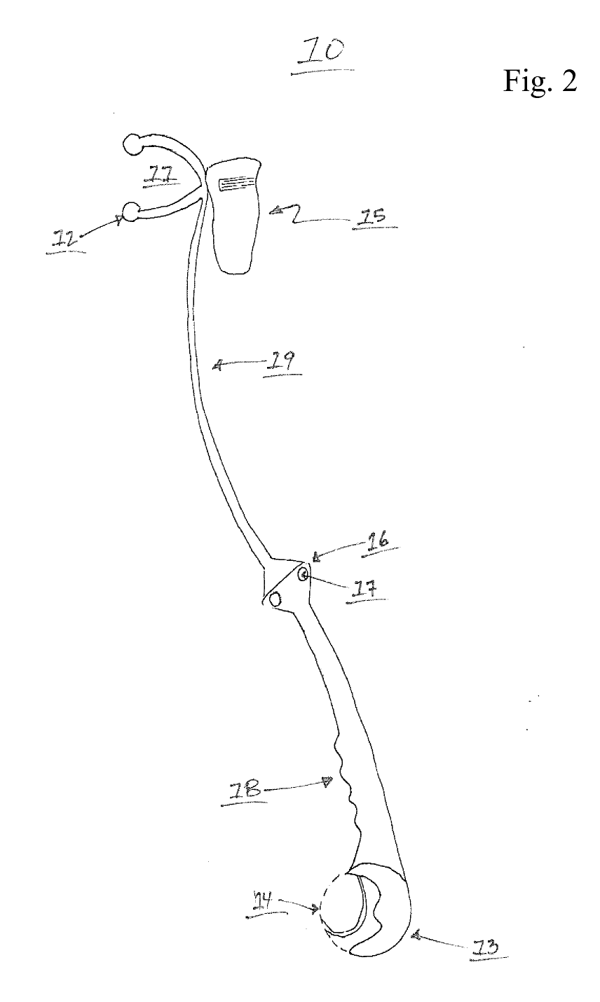

A ball throwing apparatus 10 is illustrated in a side perspective view in FIG. 2. The ball throwing apparatus is unfolded to full length at the steel pin 17 at the pivot point 16.

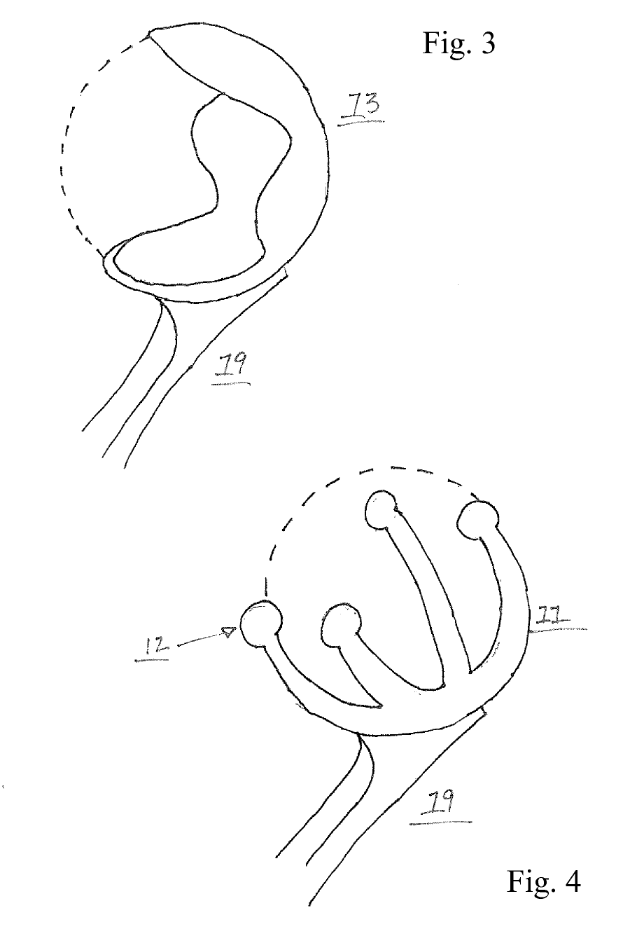

The partial spherical structure 13 of a ball throwing apparatus 10 is illustrated in a close up perspective in FIG. 3.

The claw-like structure 11 with a plurality of elongate members 12 of a ball throwing apparatus 10 is illustrated in a close up perspective in FIG. 4.

One embodiment of the present invention provides a ball throwing apparatus made from a resilient, lightweight material.

In another embodiment of the present invention, the resilient, lightweight material may be polypropylene.

In another embodiment of the present invention, the polypropylene may be slightly flexible.

In another embodiment of the present invention, the elongated shaft of the ball throwing apparatus may be a sufficient length such that a ball may be thrown great distances during use.

In another embodiment of the present invention, the elongated shaft of the ball throwing apparatus may be a sufficient length such that a ball may be engaged and retrieved without bending over by the user.

In another embodiment of the present invention, the shaft of the ball throwing apparatus comprises two distinct portions which are joined at a pivot point by a steel pin.

In another embodiment of the present invention, the shaft of the ball throwing apparatus may be folded about the pivot point such that the apparatus is reduced to approximately half its original length.

In another embodiment of the present invention, the shaft of the ball throwing apparatus has a grip-molded handle portion.

In another embodiment of the present invention, the grip-molded handle portion of the shaft further comprises a partial spherical structure.

In another embodiment of the present invention, the partial spherical structure has an inner radius equal to or slightly smaller than the radius of a tennis ball.

In another embodiment of the present invention, the partial spherical structure stores an extra tennis ball.

In another embodiment of the present invention, the shaft of the ball throwing apparatus has a curved throwing portion.

In another embodiment of the present invention, the curved throwing portion further comprises a claw-like structure with a plurality of elongate members.

In another embodiment of the present invention, the claw-like structure effectively releases a ball when the apparatus is swung in a forward, circular path.

In another embodiment of the present invention, the claw-like structure may be used to engage and retrieve a ball without the user having to touch the ball with one's hand or fingers.

In another embodiment of the present invention, the curved throwing portion further comprises a belt clip.

It will be appreciated that details of the foregoing embodiments, given for purposes of illustration, are not to be construed as limiting the scope of this invention. Although several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed:

1. A ball thrower, comprising:
a throwing arm, the throwing arm comprising a throwing end and a first joint end, wherein the throwing end and the first joint end are oppositely disposed on the throwing arm;
the throwing end holds and releases a ball;
a grip-molded handle arm, the arm comprising a storage end and a second joint end, wherein the storage end and the second joint end are oppositely disposed on the grip-molded handle arm;
the first joint end is in a hinging engagement with the second joint end; and
the storage end holds the ball.

2. The ball thrower according to claim 1, wherein the throwing end holds and releases a first ball while the storage end holds a second ball.

3. The ball thrower according to claim 1, wherein the grip-molded handle arm and the throwing arm lock in an open position.

4. The ball thrower according to claim 1, wherein the grip-molded handle arm and the throwing arm collapse to a collapsed position.

5. The ball thrower according to claim 1, wherein the ball thrower further comprises a clip.

6. The ball thrower according to claim 1, wherein the clip is removably engaged to the ball thrower.

7. The ball thrower according to claim 1, wherein the storage end and the throwing end hold a range of different sized balls.

8. The ball thrower according to claim 1, wherein the storage end holds the ball in a more secure engagement than the throwing end holds the ball.

9. The ball thrower according to claim 1, wherein the throwing end includes a plurality of elongate members that hold the ball.

10. The ball thrower according to claim 9, wherein the elongate members have an accurate shape and extend from the central portion of the throwing end to define a first holding area for holding the ball.

11. The ball thrower according to claim 9, wherein the elongate members include or terminate at rounded members, which maintain the ball in the throwing end until the ball is thrown from the throwing end.

12. The ball thrower according to claim 9, wherein the elongate members extend from a central portion, and the elongate members flex or bend with respect to the central portion to accommodate and hold a range of different sized balls.

13. The ball thrower according to claim 1, wherein the hinging engagement includes a pin that passes through portions of the first joint end and the second joint end.

14. The ball thrower according to claim 13, wherein the pin passes through pivot holes of the throwing arm and the grip-molded handle arm to provide for the hinging of the throwing arm and the grip-molded handle arm to open or collapse the ball thrower, and the pin passes through locking holes of the throwing arm and the grip-molded handle arm in order to lock the ball thrower open.

15. The ball thrower according to claim 13, wherein the pin passes through an internal diameter of the spring, and the pin is biased by the spring.

16. A ball thrower, comprising:
a throwing arm, the throwing arm comprising a throwing end;
the throwing end releases a ball during a throwing motion;
a grip-molded handle arm, the grip-molded handle arm comprising a storage end; and
the storage end holds the ball in a secure engagement.

17. The ball thrower according to claim 16, wherein the throwing end releases a first ball or a second ball, and wherein the storage end holds the first ball or the second ball in a secure engagement.

18. A ball thrower, comprising:
a first arm, the first arm comprising a throwing end and a first joint end, wherein the throwing end and the first end are oppositely disposed on the first arm;
the throwing end releases a ball;
a second arm, the second arm comprising a second joint end;
the first joint end is in a hinging engagement with the second joint end; and
the hinging engagement comprising a locking member that locks the throwing arm and the storage arm in an open position.

19. A method of using a ball thrower, comprising:
providing a ball thrower, wherein the ball thrower comprises a first arm, the first arm comprising a throwing end and a first joint end, wherein the throwing end and the first joint end are oppositely disposed on the first arm; the throwing end releases a ball; a second arm, the second arm comprising a second joint end; the first joint end in a hinging engagement with the second joint end;
opening the ball thrower;
locking the ball thrower in an open position; and
throwing the ball from the throwing end of the ball thrower.

20. The method of using the ball thrower according to claim 19, further comprising unlocking the ball thrower and collapsing the ball thrower.

21. A method of using a ball thrower, comprising:
providing a ball thrower, wherein the ball thrower comprises a throwing end and a storage end, wherein the throwing end and the storage end are oppositely disposed on the ball thrower; the throwing end releases a ball; and the storage end hold the ball;
removing the ball from the storage end;
placing the ball in the throwing end; and
throwing the ball from the throwing end of the ball thrower.

22. The method of using the ball thrower according to claim 21, further comprising throwing a first ball from the throwing end while storing a second ball in the storage end.

23. A method of manufacturing a ball thrower, comprising:
providing a first arm and a second arm, wherein the first arm comprises a throwing end to release a ball when a throwing motion is applied to the ball thrower; and,
engaging the first arm to the second arm in a hinging engagement via a hinging member;
wherein the second arm hinges relative to the first arm, wherein the hinging member locks and unlocks the second arm relative to the first arm.
